(19) United States
(12) Patent Application Publication
(10) Pub. No.: US 2009/0250390 A1
(43) Pub. Date: Oct. 8, 2009

(54) Filter

(75) Inventors: Willie L. Stamey, JR., Kings Mountain, NC (US); Mark A. Roll, Bessemer City, NC (US); Darrell T. McKenzie, Gastonia, NC (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Wix Filtration Corp LLC, Gastonia, NC (US)

(21) Appl. No.: 12/484,826

(22) Filed: Jun. 15, 2009

Related U.S. Application Data
(63) Continuation-in-part of application No. 12/337,695, filed on Dec. 18, 2008.
Application No. 12/337,695 is a continuation-in-part of application No. 11/626,586, filed on Jan. 24, 2007.

(51) Int. Cl. B01D 29/13

(52) U.S. Cl. 210/437

(57) ABSTRACT

A filter is disclosed. The filter comprises a canister, filter media disposed within the canister, the filter media having a first axial end, a second axial end and circumscribing a central axis and an end cap having an inner radial surface disposed adjacent the first axial end of the filter media, the end cap defining a centralized axial passage therethrough having a sidewall surrounding said passage that extends to a valve actuation portion that is axially offset from the inner radial surface of the end cap, wherein the actuation portion includes at least one cross member that extends from a position on the sidewall across the centralized axial passage, the cross member having a first radial surface closer to the inner radial surface of the end cap than a second radial surface, and wherein the first radial surface of the at least one cross member is substantially planar.

### RELATED APPLICATION

This application is a continuation-in-part of U.S. patent application Ser. No. 12/337,695 filed on Dec. 18, 2008, which is a continuation-in-part of U.S. patent application Ser. No. 11/626,586 filed on Jan. 24, 2007, the contents of which are fully incorporated herein by reference.

### FIELD

The disclosure generally relates to filters.

### BACKGROUND

Filters typically include filter media to remove foreign particulates, contaminates, and the like.

### BRIEF DESCRIPTION OF THE DRAWINGS

The present disclosure will now be described, by way of example, with reference to the accompanying drawings, in which:

FIG. 1 is an exploded, perspective cross-sectional view of a filter element in accordance with an exemplary embodiment of the invention;

FIG. 2 is a perspective view of an end cap of the filter element of FIG. 1 in accordance with an exemplary embodiment of the invention;

FIG. 3A is a cross-sectional view of a filter assembly in accordance with an exemplary embodiment that includes the filter element of FIG. 1;

FIG. 3B is another cross-sectional view of the filter assembly of FIG. 3A that illustrates a valve interfaced with the filter element in accordance with an exemplary embodiment of the invention;

FIG. 4 is a partial cross-sectional view of the filter assembly of FIGS. 3A-3B in accordance with an exemplary embodiment of the invention;

FIG. 5A is an enlarged cross-sectional view referenced generally according to line 5C in FIGS. 3A, 3B in accordance with an exemplary embodiment of the invention;

FIG. 5B is an enlarged cross-sectional view referenced generally according to line 5C in FIGS. 3A, 3B in accordance with an exemplary embodiment of the invention; and

FIG. 5C is an enlarged cross-sectional view of FIG. 5A according to line 5C in FIGS. 3A, 3B in accordance with an exemplary embodiment of the invention; and

### DETAILED DESCRIPTION

It is to be generally understood that the nomenclature used herein is simply for convenience and the terms used to describe the invention should be given the broadest meaning by one of ordinary skill in the art. In addition, relational terms such as radial and axial are used throughout this disclosure and the use thereof should not be interpreted as an absolute relationship. For example, the use of radial surface should not imply that the surface must be absolutely radial to a reference point and, instead, the use thereof may imply that the surface has a larger radial component than an axial component with respect to the reference point. Additionally, the terms inner and outer may be used to describe a component or surface in relation to another component or surface; accordingly, unless the context provides otherwise, an inner component or surface means that the component or surface is closer to the interior portion of the filter element than the corresponding outer component or surface. These and other descriptions should be known to one of ordinary skill in the art after considering the full breadth of this disclosure.

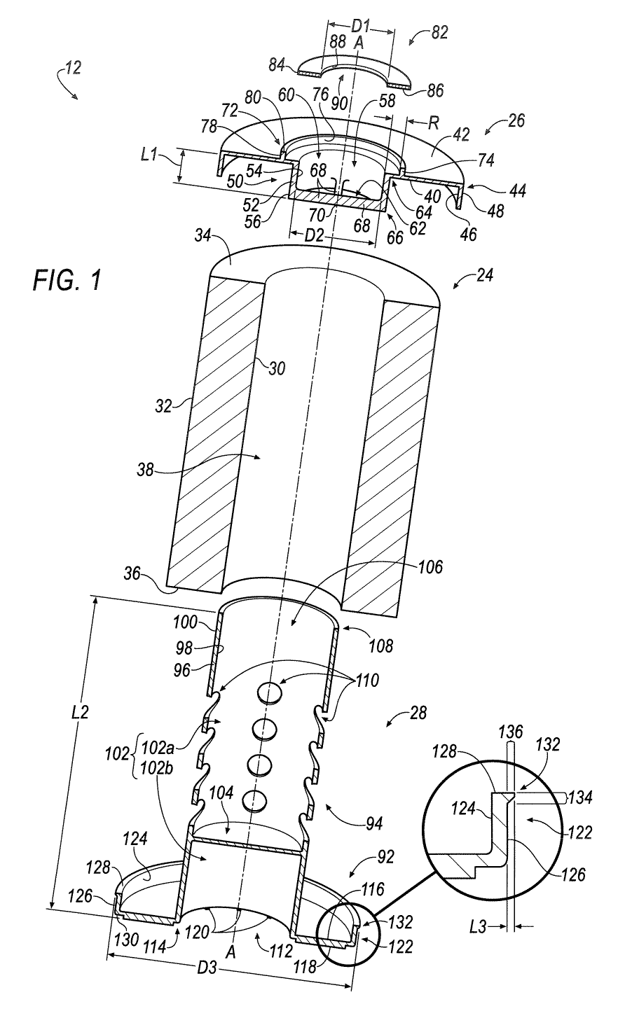

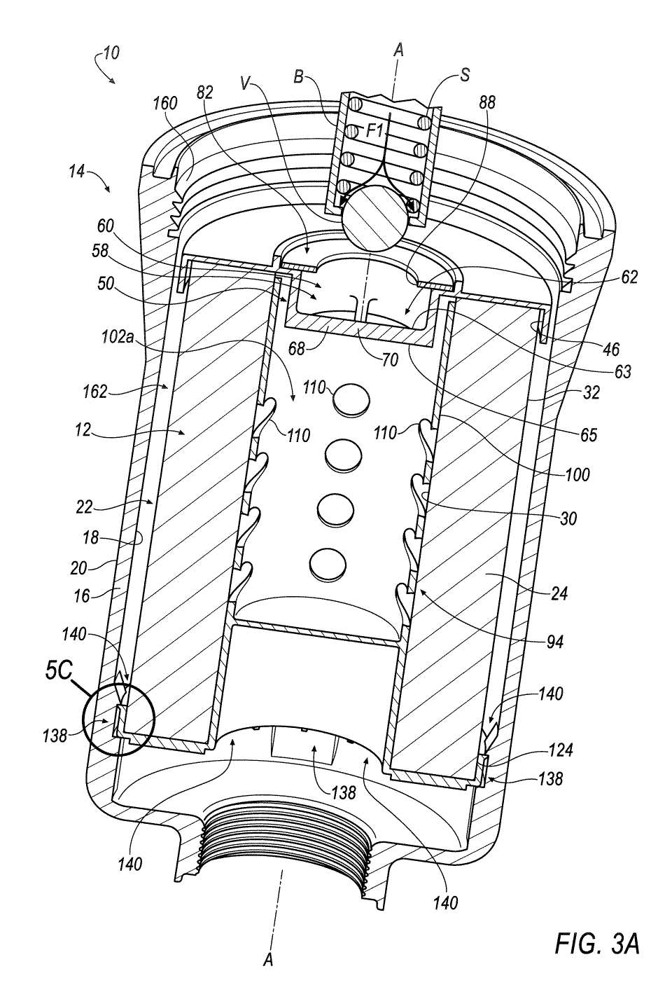

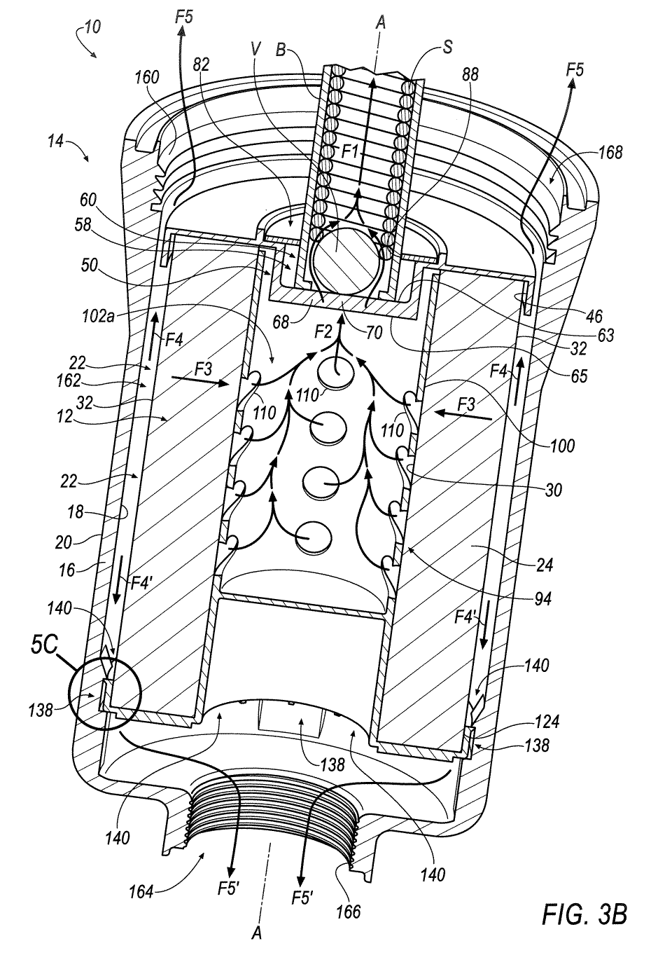

Referring to FIG. 1, a filter element is shown generally at 12 in accordance with an embodiment of the invention. FIGS. 3A and 3B depict filter element 12 resident within an exemplary canister 14. In an embodiment, canister 14 generally includes a body 16 having an inner axial surface 18 spaced radially inward in relation to an outer axial surface 20. In an embodiment, inner axial surface 18 defines a cavity 22. FIGS. 1 and 3A-3B depict an axis, A-A, extending through the filter element 12 as a positional reference for purposes of this disclosure.

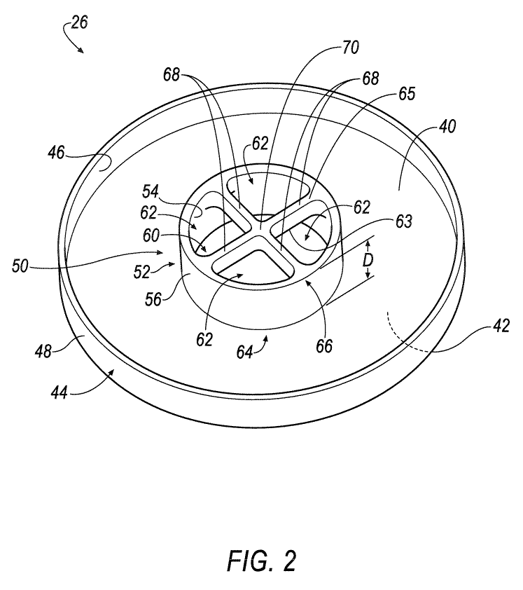

Filter element 12 includes filter media 24. In an embodiment, filter media 24 includes an inner axial surface 30 spaced radially inward in relation to an outer axial surface 32, a first axial end 34 and a second axial end 36. In an embodiment, inner axial surface 30 of filter media 24 defines an interior portion 38 between first axial end 34 and second axial end 36. Referring to FIGS. 1 and 2, an end cap 26 is provided adjacent the first axial end 34 and includes an inner radial surface 40 spaced axially inward in relation to an outer radial surface 42. In an embodiment, end cap 26 defines a centralized axial passage 58 that extends therethrough which is surrounded by a sidewall 52. In an embodiment, sidewall 52 extends axially beyond inner radial surface 40 and into the interior 38 of filter media 24 to at least a valve actuation portion 50. In an embodiment, valve actuation portion 50 is axially offset from inner radial surface 40 of end cap 26. In an embodiment, actuation portion 50 includes at least one cross member 68 that extends across at least a portion of the centralized axial passage 58 to define at least two openings 62 within passage 58. In an embodiment, and as depicted in the accompanying figures, the cross member may extend all the way across centralized axial passage 58.

In an embodiment, at least one cross member 68 includes a first surface 63 that is closer to inner radial surface 40 of end cap 26 than a second surface 65. In an embodiment, first surface 63 of the at least one cross member 68 is substantially planar. With reference now to the Figures, filter element 12 includes two cross members 68 that intersect at a center point. It should be appreciated, based on this disclosure, that any number of cross members 68 may be suitable in accordance with the following disclosure, and any intersection thereof need not occur at a central location.

In an embodiment, one or more cross members 68 may define an X-shape. In an embodiment one or more cross members 68 may be each offset by approximately 180 degrees to define four axial outlet openings 62.

In an embodiment, valve actuator portion 50 may be provided in sealing relation with end cap 26 such that fluid and the like must pass through valve actuator portion 50 to pass into radial interior portion 38 of filter media 24. In an embodiment, sidewall 52 extends axially away from inner radial surface 40 of end cap 26 at a length, L1.

Referring to FIG. 1, in an embodiment, end cap 26 may include a seal retainer portion that is shown generally at 72 and a seal 82 disposed in relation therewith. Seal retainer portion 72 may be integral with end cap 26. In an embodiment, seal retainer portion 72 may retain an axial and/or radial alignment of seal 82 (e.g., a washer seal) centralized axial passage 58 on end cap 26.

In an embodiment, seal retainer portion includes a flange 74 that extends axially away from the outer radial surface 42 of end cap 26 and axially away from filter media 24. In an embodiment, flange 74 is radially spaced outwardly in relation to the centralized axial passage 58 at a radial distance, R, to define a ledge therebetween. In an embodiment, flange 74 includes an inner axial surface 76 spaced radially inward in relation to an outer axial surface 78 and terminates at an end 80.

In an embodiment, seal 82 is a washer seal having an outer axial surface 84 disposed adjacent to inner axial surface 76 of flange 74 while an inner radial surface 86 of washer seal 82 is disposed adjacent the outer radial surface 42 of end cap 26. In an embodiment, washer seal 82 also includes an inner axial surface 88 that defines an axial passage 90 extending through washer seal 82. In an embodiment, passage 90 includes a diameter, D1, that is less than a diameter, D2, of passage 58 extending through body 52. Diameter, D2, is referenced as the diameter of centralized axial passage 58.

In an embodiment, washer seal 82 may be bonded, adhered-to, ultra-sonically weld or otherwise joined to end cap 26 such that washer seal 82 may be described to be a part of end cap 26. However, in an embodiment, washer seal 82 may be alternatively described to be a component of filter element 12 that is separate from and not a component or part of end cap 26.

Referring to FIG. 1, in an embodiment, filter element 12 includes a support member 28. Support member 28 may provide one or both of radial and axial support to filter media 24 and may facilitate a connection of filter element 12 to inner axial surface 18 of canister 14. In an embodiment, support member 28 includes an end cap portion 92 and a center tube portion 94.

For ease of disclosure, this specification and the accompanying drawings depict support member 28 having a center tube portion 94 and end cap portion 92 as being integrally connected. In one or more alternative embodiments, one or both of center tube portion 94 and end cap portion 92 may be omitted. Similarly, in an embodiment support member 28 and end cap portion 92 may be separate components.

In an embodiment, center tube portion 94 includes a tubular body 96 having an inner axial surface 98 spaced radially inward in relation to an outer axial surface 100. In an embodiment (as seen in FIGS. 3A and 3B), outer axial surface 100 of body 96 of center tube portion 94 may be disposed substantially adjacent inner axial surface 30 of filter media 24 to radially support filter media 24.

With continued reference to FIG. 1, in an embodiment, inner axial surface 98 of center tube portion 94 defines cavity 102 extending through a length, L2, of center tube portion 94. In an embodiment, cavity 102 is separated by a wall member 104 to divide cavity 102 into a first cavity portion 102a and a second cavity portion 102b. In an embodiment, wall member 104 prevents first cavity portion 102a from being in fluid communication with second cavity portion 102b.

In an embodiment, access to first cavity portion 102a is provided by an axial inlet opening 106 located at a first axial end 108 of center tube portion 94. Access to first cavity portion 102a is also provided by one or more radial outlet openings 110 formed in body 96 of center tube portion 94.

In an embodiment, access to second cavity portion 102b is provided by an axial inlet opening 112 located at a second axial end 114 of center tube portion 94. However, unlike first cavity portion 102a, access to second cavity portion 102b by way of radial passages formed in body 96 of center tube portion 94 is not provided.

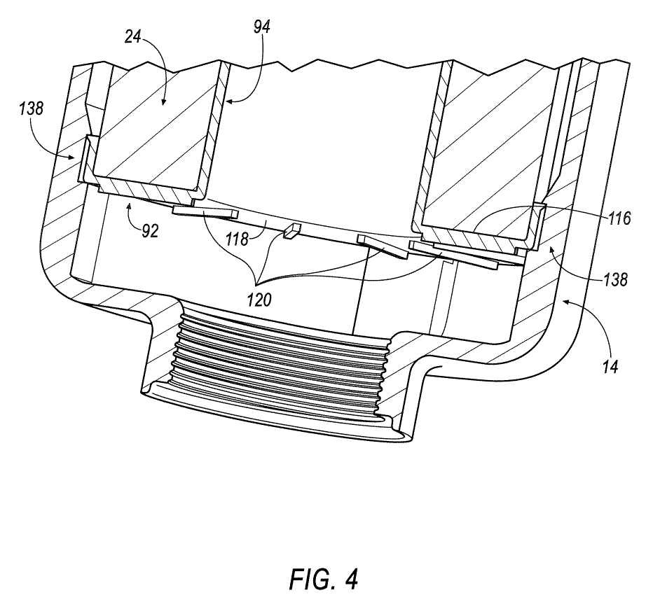

In an embodiment, end cap portion 92 is integrally formed with and extends radially outwardly from second axial end 114 of center tube portion 94. In an embodiment, end cap portion 92 includes an inner radial surface 116 spaced axially inward in relation to an outer radial surface 118. In an embodiment, inner radial surface 116 axially supports second axial end 36 of filter media 24. In an embodiment, as seen in FIGS. 1 and 4, outer radial surface 118 may also include radially-projecting stiffening ribs 120 that may further rigidify and strengthen end cap portion 92 as end cap portion 92 axially supports filter media 24.

Referring to FIG. 1, in an embodiment, end cap portion 92 includes a circumferential ring member 122 extending axially away from inner radial surface 116 toward filter media 24. In an embodiment, circumferential ring member 122 includes an inner axial surface 124 spaced radially inward in relation to an outer axial surface 126 and an outer radial surface 128 spaced radially outward from an inner radial surface 130. In an embodiment (as seen in FIGS. 3A, 3B), inner axial surface 124 radially supports outer axial surface 32 of filter media 24.

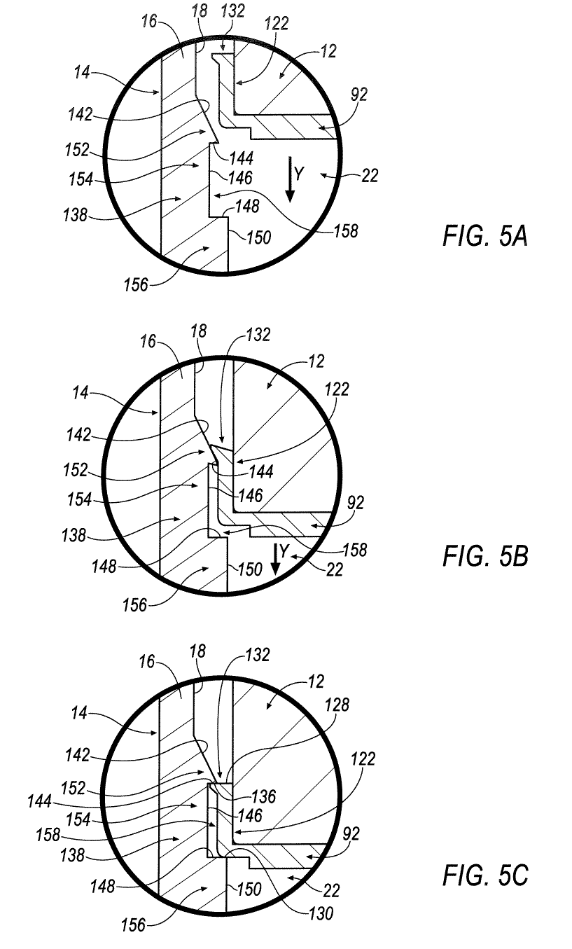

Referring to FIGS. 1 and 5A-C, in an embodiment, circumferential ring member 122 also includes a tang body 132 having a portion, or member, that extends radially outwardly from circumferential ring member 122. In an embodiment, tang body 132 may be defined by a portion 134 of outer axial surface 126 and a portion 136 of outer radial surface 128. In an embodiment, tang body 132 may project radially away from outer axial surface 126 at a length, L3, to define end cap portion 92 to include a diameter, D3.

Referring now to FIGS. 3A-3B, body 16 of canister 14 may include one or more retention members 138 located along inner axial surface 18 that facilitate a connection of filter element 12 to canister 14.

In an embodiment, canister 14 is provided with at least two retentions members 138. In an embodiment, canister 14 includes four retention members spaced from one another approximately 90 degrees apart to define four fluid flow passages 140 therebetween. It will be appreciated, however, that the number of retention members 138 is not limited to two or four and that the invention may be practiced with any desirable number of retention members 138; for example, the invention may be practiced with two, three, four, five or more retention members that may be arranged as an interrupted ring of retention members to define fluid flow passages 140 therebetween.

Referring to FIG. 5A, one of the retention members 138 is shown according to an embodiment of the invention. In an embodiment, inner axial surface 18 of canister 14 defines the retention member 138. In an embodiment, retention member 138 includes a ramp surface portion 142, a first radial surface portion 144, a first axial surface portion 146, a second radial surface portion 148 and a second axial surface portion 150.

In an embodiment, ramp surface portion 142 and first radial surface portion 144 provide a head portion 152, first radial surface portion 144 provides a neck portion 154, and second radial surface portion 148 and second axial surface portion 150 provide a shoulder portion 156.

Retention member 138 forms a radial recess 158 between shoulder portion 156 and head portion 152 to engage ring member 122 as discussed below.

The figures and this disclosure identify that the retention members 138 are part of the inner axial surface 18 of canister 14. In an alternate embodiment, retention member 138 may be separate components connected to inner axial surface 18.

As seen in FIG. 5A, connection of filter element 12 to canister 14 is permitted by disposing filter element 12 into cavity 22 according to the direction of the arrow, Y. As seen in FIG. 5B, as filter element 12 is further inserted into canister 14 according to the direction of the arrow, Y, tang body 132 contacts head portion 152. In an embodiment, as filter element 12 is further passed according to the direction of the arrow, Y, one or more of tang body 132 and head portion 152 may be elastically deformed due to diameter, D3, of end cap portion 92 being approximately equal to but slightly greater than the inner circumferential diameter defined by head portion 152 of each retention member 138.

Referring to FIG. 5C, once tang body 132 has been axially moved past ramp surface portion 142, circumferential ring member 122 of end cap portion 92 is registered within radial recess 158 of retention member 138. Further, once tang portion 132 has been axially moved past ramp surface portion 142 of head portion 152, one or more of tang body 132 and head portion 152 may be elastically deformed to substantially its original, pre-deformation shape as seen in FIG. 5A.

As seen in FIG. 5C, portion 136 of upper radial surface 128 of circumferential ring member 122 may be disposed substantially adjacent to surface portion 144 of retention member 138. Further, lower radial surface 130 of circumferential ring member 122 is disposed substantially to adjacent surface portion 148 of retention member 138. Accordingly, circumferential ring filter element 12, may be retained by and secured to inner axial surface 18 of canister 14 by way of retention member 138 such that movement of filter element 12 is substantially limited or substantially prevented.

Referring to FIG. 3A, once filter element 12 is attached to canister 14 as described above, filter assembly 10 may be connected to a body (not shown) having a threaded surface (not shown) by way of threads 160. Before, during or after attachment of filter assembly 10 to the body, filter element 12 may be brought into engagement with a valve body, B, including, for example, a ball valve, V, that is biased to a closed orientation.

In an embodiment, ball valve, V, is shown to be biased to the closed orientation by a spring, S, and, as such, ball valve, V, may be referred to as a spring-biased ball valve, V; however, it will be appreciated that ball valve, V, may be biased by means other than a spring, S, such as, for example, fluid pressure, and, as such, it will be appreciated that although the foregoing description discussed a ‘spring-biased’ ball valve, V, it will be appreciated that ball valve, V, is not limited to being biased by a spring, S.

As seen in FIG. 3B, inner axial surface 88 of seal 82 engages an outer axial surface of valve body, B, as one or more of cross members of valve actuator portion 50 engages spring-biased ball valve, V. This engagement of one or more of cross members results in spring-biased ball valve, V, being moved axially within valve body, B, such that spring-biased ball valve, V, is moved from a closed orientation (see FIG. 3A) to an open orientation (see FIG. 3B).

Because valve actuator portion 50 permits spring-biased ball valve, V, to be moved to the open orientation, fluid (e.g., fuel), may be permitted to flow between the filter element 12 and the valve V.

In an embodiment, filter assembly 10 provides an outside-in fluid flow relationship such that fluid flows according to the direction of the arrow, F1, from within cavity 22 of canister 14 exteriorly of filter media 24 and substantially radially through filter media according to the direction of arrow, F3, thereby resulting in the substantial removal of desired impurities, contaminates and the like that are contained within the fluid. Thereafter, due to the engagement of actuation portion 50 with valve, V, fluid subsequently flows through axial outlet openings 62, centralized axial passage 58 and into valve body, B.

In an alternate embodiment, filter assembly 10 may provide an inside-out fluid flow relationship such that unfiltered fluid enters the interior portion 38 of filter media 24 via valve V and subsequently passes substantially radially through the filter media 24 and enters cavity 22 exteriorly of filter media 24.

If, for example, the fluid is fuel, once the fuel is deposited into cavity 22 and exterior of the filter media 24, water may be separated from the fuel and passed according to the direction of arrow, F4′, and toward fluid flow passages 140 defined by the retention members 138 and then out of canister 14 according to the direction of arrow, F5′, by way of an outlet passage 164 formed by canister 14. In an embodiment, inner axial surface 18 may further include additional threads 166 that permit filter assembly 10 to be attached to another body (not shown) having a threaded surface (not shown) for intercepting the water removed from the fuel.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A filter, comprising:
a canister;
filter media disposed within the canister, the filter media having a first axial end, a second axial end and circumscribing a central axis; and
an end cap having an inner radial surface disposed adjacent the first axial end of the filter media, the end cap defining a centralized axial passage therethrough having a sidewall surrounding said passage that extends to a valve actuation portion that is axially offset from the inner radial surface of the end cap, wherein the actuation portion includes at least one cross member that extends from a position on the sidewall across the centralized axial passage, the cross member having a first radial surface closer to the inner radial surface of the end cap than a second radial surface, and wherein the first radial surface of the at least one cross member is substantially planar.

2. The filter according to claim 1, wherein the at least one cross member extends from a first position of the sidewall to a second position and defines at least two openings within the passage.

3. The filter according to claim 1, wherein the actuation portion includes two cross members that extend across the centralized axial passage to define four openings therewithin.

4. The filter according to claim 3, wherein the two cross members are each substantially the same thickness.

5. The filter according to claim 3, wherein the two cross members intersect.

6. The filter according to claim 5, wherein the centralized axial passage is substantially circular and the two cross members intersect at a center point thereof.

7. The filter according to claim 3, further including a support member disposed adjacent the second axial end of the filter media and within a cavity defined by the filter media, the support member including a second end cap disposed adjacent to the second axial end of the filter media to axially support the filter media.

8. The filter according to claim 7, wherein the canister includes a first axial end portion and a second axial end portion, the end cap being arranged closer to the first axial end portion than the second axial end portion, the filter element further comprising:
at least two retention members disposed upon the inner axial surface of the canister in a circumferential relationship, wherein the at least two retention members each include a retaining portion disposed between a ramped portion and a shoulder portion, the ramped portion being closer to the first axial end portion of the canister than the shoulder portion or the retaining portion.

9. The filter according to claim 8, wherein the second end cap includes a circumferential ring member extending axially away from an outer diameter of the end cap and towards the first end cap, wherein the circumferential ring member includes a tang body extending radially outwardly from the circumferential ring member to secure the filter element to an inner surface of the canister.

10. The filter according to claim 9, wherein the actuation portion includes two cross members that extend across the centralized axial passage to define four openings therewithin.

11. The filter according to claim 10, wherein the second end cap is annular and defines a central opening at an inner diameter thereof, and the support member includes a tubular member axially extending from the inner diameter of the second end cap into an interior portion of the filter media towards the first end cap.

12. The filter according to claim 11, wherein the tubular member includes an impervious wall that axially separates the tubular member into a first cavity separated from a second cavity such that fluid resident within the first cavity must pass through the filter media to reach the second cavity and vice versa.

13. The filter according to claim 9, wherein the end cap includes an outer radial surface opposite the inner radial surface and a seal retainer portion having a body that extends axially away from the outer radial surface and axially away from the second end cap.

14. The filter according to claim 13, wherein the body of the seal retainer portion is radially offset from the sidewall such that a ledge is defined therebetween.

15. The filter according to claim 14 further comprising:
an annular seal disposed around the centralized axial passage, the seal axially supported by the ledge and having a portion that extends radially into the centralized axial passage.

16. The filter according to claim 15, wherein the seal is a washer seal having an inner lip that defines an opening to seal against an outer radial surface of a valve body.

17. The filter according to claim 7, wherein the second end cap is annular and defines a central opening at an inner diameter thereof, and the support member includes a tubular member axially extending from the inner diameter of the second end cap into an interior portion of the filter media towards the first end cap.

18. The filter according to claim 17, wherein the tubular member includes an impervious wall that axially separates the tubular member into a first cavity separated from a second cavity such that fluid resident within the first cavity must pass through the filter media to reach the second cavity and vice versa.

19. The filter according to claim 1, wherein the end cap includes an outer radial surface opposite the inner radial surface and further includes a seal retainer portion having a body that extends away from the outer axial surface and axially away from the second axial end of the filter media.

20. A filter, comprising:
a canister having an inner surface, an outer surface, a first axial end and a second axial end, the inner surface defining a cavity between the first axial end and the second axial end;
retention members circumferentially located around the inner surface of the canister closer to the first axial end then the second axial end, the retention members having a retaining portion disposed between a ramp portion and a shoulder portion and defines a recess therebetween, wherein the ramp portion is closer to the second axial end then the retaining portion;
filter media disposed within the cavity, the filter media having an inner axial surface, an outer axial surface, a first axial end, and a second axial end;
an annular end cap disposed adjacent to the second axial end of the filter media having a circumferential ring member extending axially away from an outside diameter of the end cap and axially toward the filter media, wherein the circumferential ring defines a tang having a portion that extends radially outwardly, and further wherein the tang is registered within the recess of the retaining portion;
a center tube axially extending from an inside diameter of the annular end cap into an interior portion of the filter media,
a second end cap disposed adjacent to the first axial end of the filter media and having an inner radial surface and an outer radial surface, wherein the end cap defines a centralized axial passage between the inner radial surface and the outer radial surface and includes a sidewall surrounding the centralized axial passage that further extends axially away from the inner radial surface of the end cap and into an interior portion of the filter media to a valve actuation portion, wherein the valve actuation portion includes at least two cross members that extend across the centralized axial passage, the cross members having a first radial surface closer to the inner radial surface of the end cap than a second radial surface, wherein the first radial surface of the at least one cross member is substantially planar.
